(19) United States
(12) Patent Application Publication
(10) Pub. No.: US 2024/0156655 A1
(43) Pub. Date: May 16, 2024

(54) APPARATUS FOR LIFTING OBJECTS

(71) Applicant: Tyther LLC, Las Vegas, NV (US)

(72) Inventor: Tyler Rex Frehner, Las Vegas, NV (US)

(73) Assignee: Tyther LLC, Las Vegas, NV (US)

(21) Appl. No.: 18/388,583

(22) Filed: Nov. 10, 2023

Related U.S. Application Data
(60) Provisional application No. 63/384,041, filed on Nov. 16, 2022.

(51) Int. Cl. A61G 1/003

(52) U.S. Cl. CPC A61G 1/003

(57) ABSTRACT

A patient transport device comprises a pair of straps overlaying each other; and a plurality of stich elements joining the straps to each other at junctions defining passages therebetween.

### CROSS-REFERENCE TO RELATED APPLICATIONS

This application claims the benefit of U.S. Provisional Patent Application No. 63/384,041, filed on Nov. 16, 2022, entitled “APPARATUS FOR LIFTING OBJECTS”, which is hereby incorporated by reference in its entirety for all that is taught and disclosed therein.

### FIELD OF THE INVENTION

The present invention relates to straps for lifting objects.

### BACKGROUND AND SUMMARY

Firefighters, EMS providers, orderlies and hospital staff often need to lift bariatric or geriatric people who have fallen and are unable to get up or simply need to be moved. These people often have low muscle mass, which makes them difficult to move, and they may fall in locations that are difficult to access, like a shower or bathtub.

Lifters often use towels or sheets to allow two or more people to lift the person at the same time, but these makeshift lifting devices are difficult to grip. Other lifting devices, like the Megamover® allow multiple lifters to lift the person at the same time, but these devices are single use, and they can be difficult to position under the person, especially when the person falls in a confined space. These devices are also single-purpose, and they cannot be easily used to lift or drag objects other than fallen people.

The above disadvantages are addressed by a patient transport device that comprises a pair of straps overlaying each other; and a plurality of stich elements joining the straps to each other at junctions defining passages therebetween.

### BRIEF DESCRIPTION OF THE DRAWINGS

FIG. 1 is a block diagram illustrating an example lifting device.

FIG. 2A is a front view of an example strap member.

FIG. 2B is a top view of an example strap member.

FIG. 3A is a front view of an example of a use for the lifting device.

FIG. 3B is a side view of an example of a use for the lifting device.

FIG. 4 is a side view of another example of a use for the lifting device.

FIG. 5 is a front view of another example of a use for the lifting device.

FIG. 6A is a top view of an example strap holder.

FIG. 6B is a bottom view of an example strap holder.

FIG. 6C is a front view of an example strap holder.

FIG. 6D is a front view of an example strap holder in its closed configuration.

FIG. 7A is a front view of an example pouch.

FIG. 7B is a back view of an example pouch.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Embodiments of the present disclosure will be described more thoroughly from now on with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples. Throughout this specification, plural instances (e.g., “250”) can implement components, operations, or structures described as a single instance. Further, plural instances (e.g., “250”) refer collectively to a set of components, operations, or structures described as a single instance. The description of a single component applies equally to a like-numbered component unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

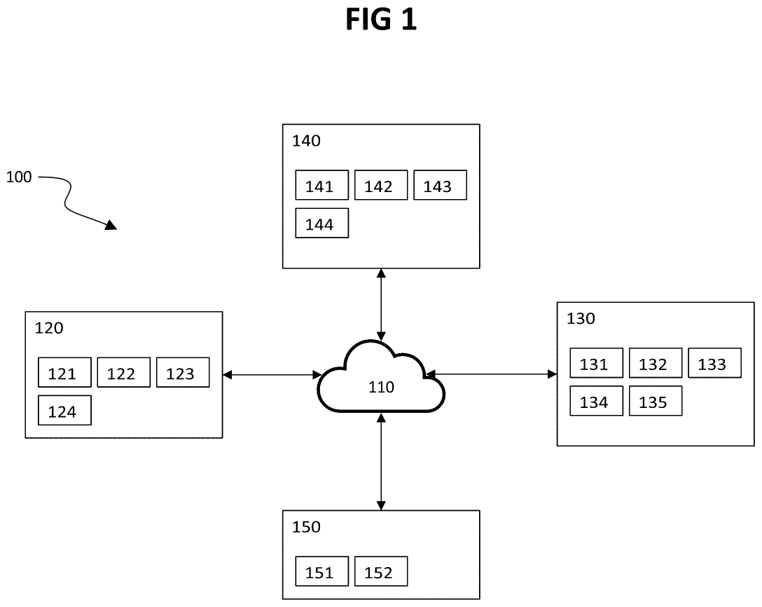

FIG. 1 is a block diagram illustrating an example lifting device 100, in accordance with one or more embodiments. Using embodiments of the strap member 110 disclosed herein, a lifter or more than one lifter 120 can lift, drag, or move an object 130. For example, a lifter 120, such as a firefighter 121, EMS provider 122, orderly 123, or hospital staff member 124 may use the embodiments to lift or otherwise move an object 130. The lifter 120 may use the embodiments to lift an object 130, such as a bariatric person 131, geriatric person 132, person with a physical limitation 133, unconscious person 134, or inanimate object 135. Embodiments of the strap member 110 can be used in different settings 140, for example, fire emergencies 141, hospitals 142, police responses 143, and warzones 144. Embodiments of the lifting device 100 may include accessories 150, such as a strap holder 151, or a pouch 152.

### The Strap Member

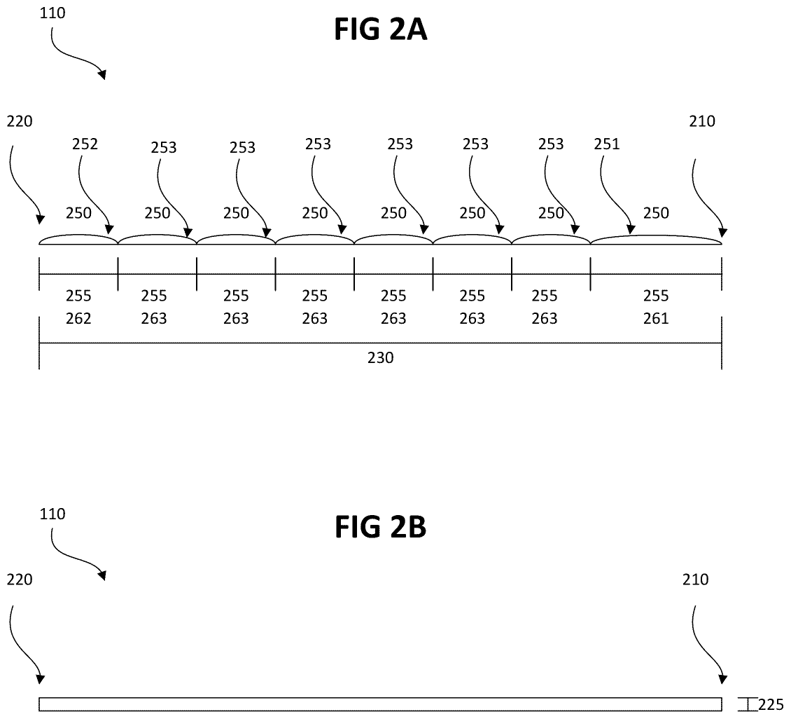

In embodiments of the present disclosure, for example in FIGS. 2A and 2B the lifting device 100 of the present disclosure has a strap member 110. In embodiments the strap member 110 is a longitudinal strap member 110. The strap member 110 may have a strap first end 210. The strap member 110 may have a strap second end 220. The strap member 110 may have a strap first end 210 and a strap second end 220 separated by a strap length 230.

In embodiments, the strap member 110 includes multiple loop members 250. The loop members 250 may be disposed along the strap member 110 between the strap first end 210 and the strap second end 220. In embodiments the strap member 110 includes 5 to 10, 6 to 9, or 7 to 8 loop members 250. For example, the number of the loop members 250 may be in a range of 5 to 10. In embodiments, the strap member 110 includes 7, 8, or 9 loop members 250 In embodiments, the strap member 110 includes 8 loop members 250.

The loop members 250 may include a circular loop having an opening. In embodiments the opening of the loop members 250 are oriented in a direction that is perpendicular to the strap length 230 of the strap member 110. In embodiments, the loop members 250 are aligned in single file such that the loop members 250 do not overlap.

The loop members 250 may each have a loop diameter 255. The loop diameter 255 of at least one loop member 250 may be different from another loop diameter 255 of at least one other loop member 250 of the loop members 250. In embodiments, the strap member 110 has a first loop member 251, which is proximal to the strap first end 210. The strap member 110 may have a second loop member 252, which is proximal to the strap second end 220. In embodiments, a loop diameter 255 of at least one loop member 250 of the loop members 250 may be different from another loop diameter 255 of at least one other loop member 250 of the loop members 250.

In embodiments, the strap member 110 has a first loop member 251 which is sized to encircle or grasp a shoulder of a lifter 120 while the lifter is lifting an object 130. For example, the lifter 120 lifting the object 130 may place all or a portion of the lifter's arm through the first loop member 251 to partially secure the strap member 110 to the lifter 120 as the lifter lifts the object 130. In embodiments, the strap member 110 has a second loop member 252 that is sized to encircle or grasp a shoulder of a lifter 120 or a second shoulder of the lifter 120 or a second should of a second lifter 120. In embodiments, the strap member 110 has a first loop member 251 and a second loop member 252 that are both sized to encircle or grasp a shoulder of a lifter 120 lifting the object.

In embodiments, the strap member 110 has at least one center loop member 253, which is a loop member 250 that is different from the first loop member 251 and the second loop member 252. The at least one center loop member 253 may be disposed between the first loop member 251 and the second loop member 252. The at least one center loop member 253 may be sized to encircle or grasp a hand or wrist of a lifter 120, a second lifter 120, or a third lifter 120 who is lifting the object 130.

In embodiments, the strap member 110 has center loop members 253 having center loop diameters 263. The first loop member 251 may have a first loop diameter 261 that is greater than the center loop diameters 263. The second loop member 252 may have a second loop diameter 262 that is greater than the center loop diameters 263. In embodiments, the first loop diameter 261 and the second loop diameter 262 are both greater than the center loop diameters 263.

In embodiments, the strap member 110 has a strap length 230 that is sized to encircle a large object 130 intended to be lifted. For example, the strap member 110 may have a strap length 230 that is sized to encircle a bariatric person 131. In embodiments the strap length 230 of the strap member 110 is about 50 to 100, 60 to 90, or 70 to 80 inches long. In embodiments the strap length 230 of the strap member 110 is about 74 to 78 inches long. The strap member 110 may have a width 225 that is sized to strengthen the strap member 110. The strap member 110 may have a width 225 that is sized to properly support the object 130 to be lifted. In embodiments, the strap member 110 has a width of about 1 to 3 inches. In embodiments, the strap member 110 has a width of about 2 inches. The strap member 110 may have a thickness that is sized to give the strap member 110 strength to support the object 130 intended to be lifted.

In embodiments, the loop members 250 each have different loop diameters 255 that are sized to encircle or grasp a lifter's shoulder, hand, and/or wrist. For example, the loop members 250 may have a loop diameter 255 of 5 to 16 inches. In embodiments, at least one of the loop members 250 has a loop diameter 255 of 5 to 9 inches such that the loop member 250 is sized to encircle or grasp a lifter's hand or wrist. In such embodiments, the loop members 250 sized to encircle or grasp a lifter's hand may have a loop diameter 255 of 6 to 8 inches. In embodiments, at least one of the loop members 250 has a loop diameter 255 of 14 to 16 inches such that the loop member 250 is sized to encircle or grasp a lifter's shoulder. In such embodiments, the loop members 250 sized to encircle or grasp a lifter's shoulder may have a loop diameter 255 of 15 inches. In embodiments the first loop member 251 has a first loop diameter 261 of about 15 inches. In embodiments, the second loop member 252 has a second loop diameter 262 of 6 to 8 inches or 15 inches. In embodiments, the center loop members 253 has center loop diameters 263 of 6 to 8 inches. For example, the strap member 110 may have 8 loop members 250 having the following loop diameters 255 listed from a strap first end 210 to a strap second end 220: 8 inch, 8 inch, 8 inch, 8 inch, 8 inch, 8 inch, 8 inch, 15 inch. In another example, the strap member 110 may have the following loop diameters 255: 8 inch, 8 inch, 8 inch, 8 inch, 6 inch, 8 inch, 8 inch, 15 inch. In another example, the strap member 110 may have the following loop diameters 255: 15 inch, 8 inch, 8 inch, 8 inch, 8 inch, 8 inch, 8 inch, 15 inch.

The loop members 250 of the strap member 110 may be integrated with each other such that loop members 250 that are adjacent to each other form a single unit. Alternatively, the loop members 250 of the strap member 110 may be sewn or otherwise attached to adjacent loop members 250 using a method that produces a strong connection, as known to those in the art. Loop member 250 of the strap member 110 may be directly attached to adjacent loop members 250. Alternatively, a loop member 250 of the strap member 110 may be attached to an adjacent loop member 250 with a span of material between the two adjacent loop members 250.

In embodiments, the strap member 110 is made of a material that is strong, capable of lifting heavy loads, durable, less prone to wear and tear, and/or unlikely to stretch. For example, the strap member 110 may be made of a seat belt webbing. In embodiments, the strap member 110 is woven from high tensile polyester filament yarn. The strap member 110 may be 100% polyester. The strap member 110 may be sewable bonded nylon. The strap member 110 may include both 100% polyester and sewable bonded nylon. In embodiments, the strap member 110 has low water-absorption and is mildew and rot-resistant. In embodiments, the strap member 110 includes box stitching, bar tack stitching, double tac stitching, double tac stitching with diamond in the middle, and/or tight zig stitching. The strap member 110 may be configured to tolerate a resistance of up to 6,000 lbs.

### Example Uses for the Lifting Device

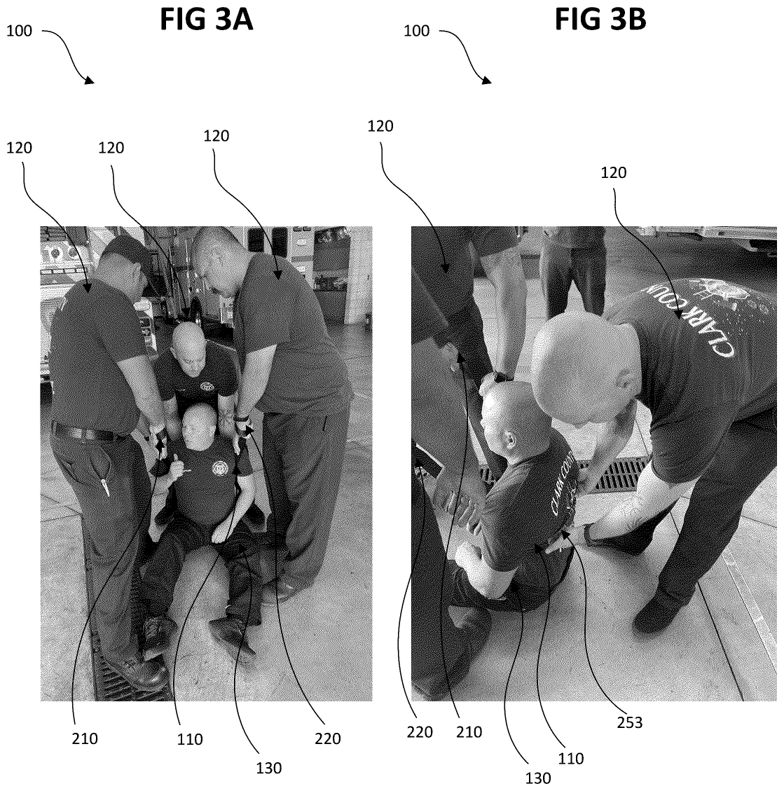

The lifting device 100 of the present disclosure may have a variety of functions and uses. For example, as shown in FIGS. 3A and 3B, the lifting device 100 may be used to allow more than one lifter 120 to lift a person or object 130 from the ground. In this example, the strap member 110 may be wrapped around the person or object 130 to be lifted, allowing a first lifter 120 to lift from a first loop member 251 at a respective strap first end 210. A second lifter 120 can lift from a second loop member 252 at a respective strap second end 220. And a third lifter 120 may lift from a center loop member 253.

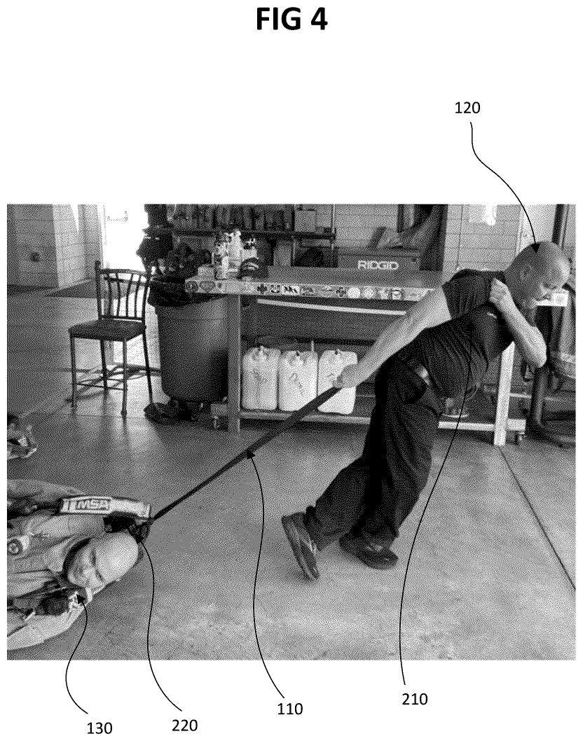

In another example, as shown in FIG. 4, the lifting device 100 may be used to allow a lifter 120 to drag a person or object 130. In this example, a lifter 120 may hold the strap member 110 by fitting the first loop member 251 at a respective strap first end 210 around the shoulder of the lifter 120. The strap second end 220 may be attached to the person or object 130 being lifted. The lifter 120 may then use the strap member 110 to drag the person or object 130.

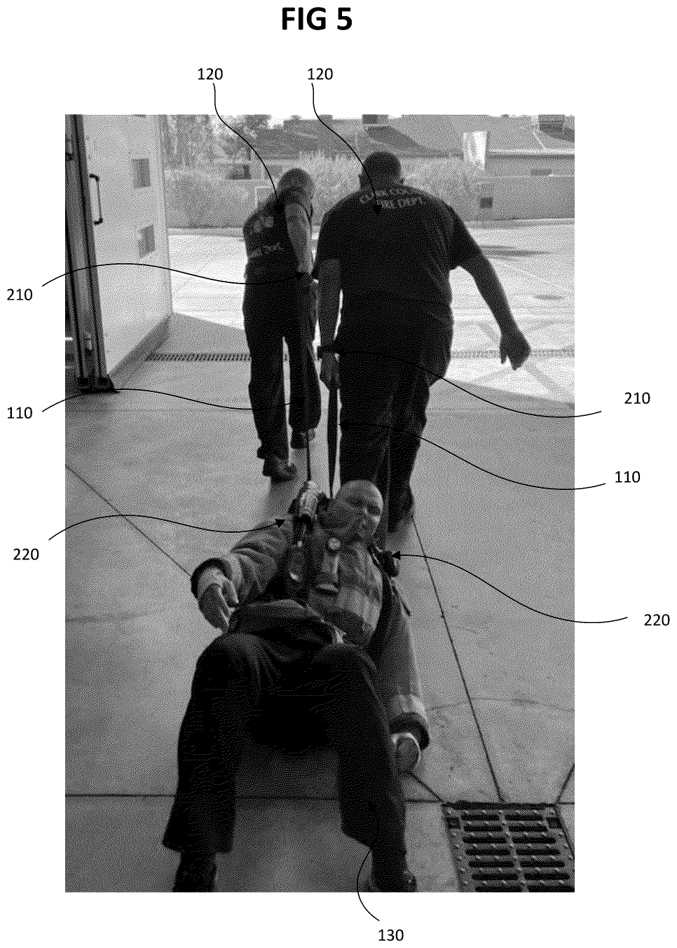

In another example, as shown in FIG. 5, the lifting device 100 may be used to allow more than one lifter 120 to drag a person or object 130. In this example, a first lifter 120 may hold the strap member 110 by fitting the first loop member 251 at a respective strap first end 210 around the shoulder of the first lifter 120. The strap second end 220 may be attached to the person or object 130 being lifted. A second lifter 120 may hold a second strap member 110 by fitting the first loop member 251 at a respective strap first end 210 around the shoulder or hand of the second lifter 120. Together, the first lifter 120 and second lifter 120 may drag the person or object 130 to be lifted.

### Lifting Device Accessories

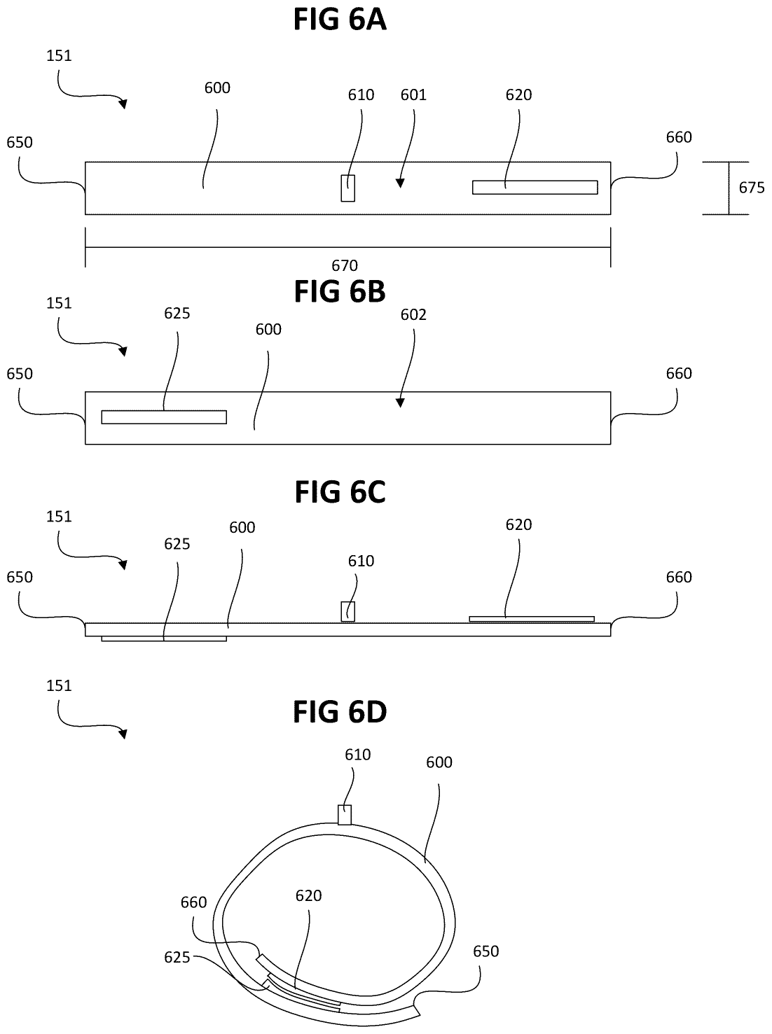

The lifting device 100 of the present disclosure may include one or more accessories 150. For example, as shown in FIG. 6A-6D, the lifting device 100 may include a strap holder 151 configured to hold the strap member 110. The strap holder 151 may hold the strap member 110 when not in use. The strap member 110 may be folded or rolled into a compact configuration. The strap holder 151 may be configured to hold the strap member 110 when the strap member 110 is in the compact configuration. The holder strap 600 may have a first holder strap end 660 and a second holder strap end 650. The first holder strap end 660 and the second holder strap end 650 may be separated by a holder strap length 670. The holder strap 600 may be a longitudinal holder strap 600.

The strap holder 151 may include a holder strap 600 that is configured to encircle the strap member 110 when it is in its compact configuration. In various embodiments, the holder strap 600 may have a first holder strap fastening member 620 disposed on a holder strap first side 601 proximal to the first holder strap end 660. The holder strap 600 may have a second holder strap fastening member 625 disposed on a holder strap second side 602 proximal to the second holder strap end 650. In such embodiments, the holder strap 600 may have a closed configuration (as shown in, for example, FIG. 6D), where the holder strap 600 curves such that the first holder strap fastening member 620 contacts the second holder strap fastening member 625. The first holder strap fastening member 620 and the second holder strap fastening member 625 may include any suitable material to removably attach the first holder strap fastening member 620 and the second holder strap fastening member 625. For example, the first holder strap fastening member 620 may releasably attach to the second holder strap fastening member 625 by a hook and loop attachment.

The holder strap 600 may be sized to encircle the strap member 110 when the strap member 110 is in the compact configuration. For example, the holder strap 600 may have a holder strap length 670 that is about 9 to 13 or 10 to 12 inches long. The holder strap 600 may have a holder strap length 670 that is sized such that the holder strap 600 has a diameter of 2 to 4 inches when the holder strap 600 is in its closed configuration. The holder strap 600 may have a holder strap width 675 that is about 0.5 to 1.5 inches long. The holder strap 600 may have a holder strap width 675 that is about 1 inch long. The holder strap 600 may have a thickness suitable to provide durability and strength to the holder strap 600. The holder strap 600 may be made of the same material as the strap member 110. The holder strap 600 may be made of any suitable material known by one of skill in the art.

The holder strap 600 may have a holder strap connector 610. The holder strap connector 610 may be configured to allow a user to connect the holder strap 600 to a different object (e.g. a belt clip). For example, in embodiments the holder strap 600 has a holder strap connector 610 that is a loop. The holder strap connector 610 may include any suitable structure known to a person of skill in the art. The holder strap connector 610 may also be configured to attach directly to a belt or Modular Lightweight Load-carrying Equipment (“MOLLE”).

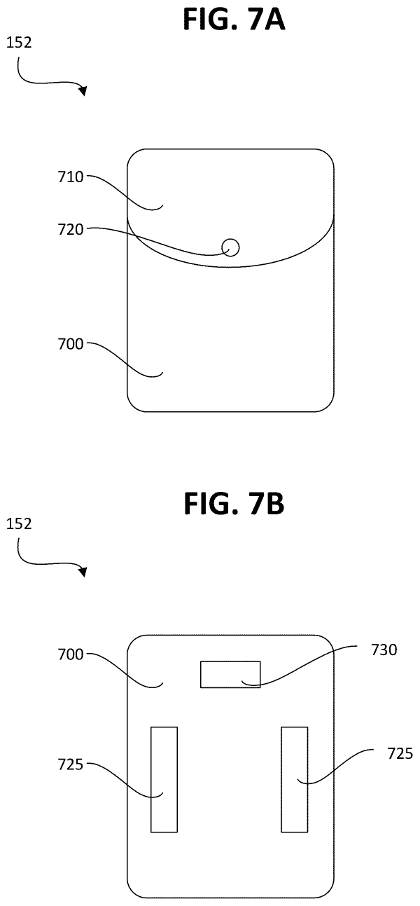

The lifting device 100 may also include a pouch 152, as shown in, for example FIGS. 7A and 7B. The pouch 152 may include a compartment 700 that is configured to receive the strap member 110. The compartment 700 may be sized to receive the strap member 110 when the strap member 110 is in its compact configuration. For example, the compartment 700 may be 4 to 8 or 5 to 7 inches tall. In embodiments, the compartment 700 is 6 inches tall. The compartment 700 may be 2 to 3 inches wide. In embodiments, the compartment 700 is 2.5 inches wide.

The pouch 152 may also have a closing element 710 that allows the pouch 152 to have an open configuration and a closed configuration. The closing element 710 may be any suitable structure to prevent the strap member 110 from falling out of the compartment 700, when the pouch 152 is in its closed configuration. The pouch 152 may also have a fastening member 720 that is configured to secure the closing element 710, such that the pouch 152 remains in its closed configuration.

The pouch 152 may have attachment members (e.g. 725 and 730) configured to attach the pouch 152 to an object. For example., the pouch 152 may have one or more clip loops 730 configured to receive a clip, hook, or other fastener. The pouch 152 may also have one or more anchor members 725 which are configured to attach to a belt or MOLLE.

From the foregoing, it will be appreciated that specific embodiments of the invention have been described herein for purposes of illustration, but that various modifications may be made without deviating from the scope of the invention. Accordingly, the invention is not limited except as by the appended claims.

### DETAILED DESCRIPTION OF A PREFERRED EMBODIMENT

Disclosed in the application is an apparatus for lifting an object. The apparatus includes a longitudinal strap member having a strap first end and a strap second end separated by a strap length. The strap member includes multiple loop members disposed along the strap member between the strap first end and the strap second end. A loop diameter of at least one loop member is different from another loop diameter of at least one other loop member.

The apparatus may have 5 to 10 loop members. The apparatus may have 6 to 9 loop members. The apparatus may have 7 to 8 loop members. The apparatus may have 8 loop members.

The apparatus may have a first loop member that is proximal to the strap first end, where the first loop member is sized to encircle or grasp a shoulder of a lifter while the lifter is lifting the object. The apparatus may also have a second loop member of the plurality of loop members is proximal to the strap second end, where the second loop member is sized to encircle or grasp a second shoulder of the lifter or a second lifter while the lifter is lifting the object.

The apparatus may include at least one center loop member different from the first loop member and the second loop member, where center loop members are disposed between the first loop member and the second loop member. At least one center loop member may be sized to encircle or grasp a hand of the lifter, the second lifter, or a third lifter while the lifter is lifting the object.

The apparatus may include a first loop member proximal to the strap first end, where the first loop member has a first loop diameter. The apparatus may also include a second loop member that is proximal to the strap second end, and the second loop member has a second loop diameter. The apparatus may also include center loop members that are disposed between the first loop member and the second loop member, where the center loop members have center loop diameters, and the first loop diameter is greater than the plurality of center loop diameters. The apparatus may also have a second loop diameter that is greater than the center loop diameters.

The apparatus may include a seat belt webbing.

The apparatus may have loop members that are attached as a single unit. The apparatus may have loop members that are directly attached to adjacent loop members. The apparatus may have loop members that are attached to adjacent loop members with a span of material between each loop member and its adjacent loop member. The apparatus may also include a holder that is a longitudinal holder strap having a first holder strap end and a second holder strap end separated by a holder strap length; a first holder strap fastening member attached at the first holder strap end; and a second holder strap fastening member attached at a second holder strap end. The holder strap may also include a holder strap connector.

The apparatus may also include a pouch. The pouch includes a compartment that is configured to receive the strap member. The pouch may also have a closing element that allows the pouch to have an open configuring and a closed configuration; and a fastening member that is configured to secure the closing element when the pouch is in the closed configuration. The pouch may also include an attachment member configured to attach the pouch to an object.

I claim:

1. A patient transport device comprising;
a pair of straps overlaying each other; and
a plurality of stich elements joining the straps to each other at junctions defining passages therebetween.
